(19) United States
(12) Patent Application Publication
(10) Pub. No.: US 2023/0159075 A1
(43) Pub. Date: May 25, 2023

(54) REMOVABLE ELECTRIC PROPULSION SYSTEM FOR A ROLLING OBJECT COMPRISING A FOLDABLE SEATING DEVICE

(71) Applicant: IFP Energies nouvelles, RUEIL-MALMAISON CEDEX (FR)

(72) Inventors: Stephane VENTURI, RUEIL-MALMAISON CEDEX (FR); Bertrand LECOINTE, RUEIL-MALMAISON CEDEX (FR)

(21) Appl. No.: 17/912,100

(22) PCT Filed: Mar. 8, 2021
(86) PCT No.: PCT/EP2021/055771

§ 371 Date: Sep. 16, 2022

(30) Foreign Application Priority Data
Mar. 19, 2020 (FR) FR2002680

(51) Int. Cl. B62B 5/00; B62B 5/08; A61G 7/08

(52) U.S. Cl. CPC B62B 5/005; B62B 5/085; B62B 5/087; B62B 5/0043; A61G 7/08; B62B 2202/90

(57) ABSTRACT

The invention relates to a removable electric propulsion system (1) for a rolling object, propulsion system (1) comprising a frame (2) provided with at least one wheel (3) driven by an electric machine (10), and at least one non-driven wheel (4), and means (5) for coupling propulsion system (1) to the rolling object. In addition, coupling means (5) comprise means for gripping and lifting at least one wheel of the rolling object. Besides, propulsion system (1) comprises a seating device with a seat (51) and a backrest (50), and this seating device is foldable between a deployed position allowing a user to sit and a folded position.

The invention also relates to a method for deploying/folding the seating device of electric propulsion system (1).

### FIELD OF THE INVENTION

The invention relates to the field of transport of rolling objects, in particular rolling beds, hospital beds for example.

Moving rolling heavy loads can lead to difficulties for users, in particular if this action is repeated, such as musculoskeletal disorders.

### BACKGROUND OF THE INVENTION

In order to make the movement of rolling heavy loads easier and more ergonomic, it has been considered to equip these heavy loads with electric machines. For example, a first idea has consisted in providing each hospital bed with an electric wheel drive system. Such a solution is expensive because it requires changing or modifying all the beds, which hospitals cannot afford. Furthermore, the drive system and its battery increase the weight of the bed. Therefore, when the battery is discharged, the effort required to move the bed is greater.

Similarly, in the field of logistics or trade, it has been envisaged to make all trolleys electric. Again, such a solution is expensive.

One alternative is to provide a removable propulsion system for rolling objects. Several technical solutions have been considered.

For example, patent application WO-01/85,086 describes a motorized propulsion system for a bed. The propulsion system is configured for coupling to one or more points of the bed. Due to the coupling means provided for this propulsion system, this system cannot be universal and suitable for different rolling objects. Indeed, it cannot be coupled to a rolling object not provided with a coupling part. In addition, for this propulsion system, all the wheels of the rolling object remain in contact with the floor. Therefore, the orientation of the coupled assembly (propulsion system and bed) is more complicated, the frictional forces are high and the motorized wheel requires more power.

Patent application WO-2012/171,079 describes a second propulsion system for a hospital bed. The propulsion system is configured to lift two wheels of the bed. However, the wheel gripping mechanism is complex and bulky: the lateral dimension (direction parallel to the axis of the motorized wheels) is great (greater than the width of the bed wheels) and it can exceed the lateral dimensions of the bed, which may be inconvenient for moving the bed, in particular in a reduced space such as a hospital corridor or lift.

Patent application WO-2013/156,030 describes a third propulsion system for a hospital bed. The propulsion system is configured to lift two wheels of the bed. However, the system has great lateral (direction parallel to the axis of the motorized wheels) and longitudinal (direction perpendicular to the axis of the wheels) dimensions: the rear platform protrudes from the bed and the distance between the non-motorized wheels can exceed the dimensions of the bed, which may be inconvenient for moving the bed, in particular in a reduced space such as a hospital corridor or lift.

Besides, the systems of the prior art are not very adaptable. Thus, the user may be faced with an incompatibility of the system with the situation they are facing. For example, a stretcher-bearer using the system may be called to carry a hospital bed but, upon arrival, the situation may have changed and the stretcher-bearer may be asked to transport the patient in a seated position. They therefore need to find a wheelchair, which takes time and requires adapted logistics. Conversely, they may be asked to transport someone initially in a seated position but, upon arrival, transport in a seated position may prove to be risky or even impossible, therefore the equipment they are to use, i.e. the propulsion system, needs to rapidly adapt to the change in situation so as to allow the hospital bed to be moved.

To address the problems of the prior art and in order to improve the flexibility of the propulsion system and its adaptation to different situations, the invention relates to a removable electric propulsion system for a rolling object, the propulsion system comprising a frame provided with at least one wheel driven by an electric machine, and at least one non-driven wheel, and means for coupling the propulsion system to the rolling object. In addition, the coupling means comprise means for gripping and lifting at least one wheel of the rolling object. Besides, the system comprises a seating device with a seat and a backrest, and this seating device is foldable between a deployed position allowing a user to sit and a folded position.

### SUMMARY OF THE INVENTION

The invention relates to a removable electric propulsion system for a rolling object, said propulsion system comprising a frame provided with at least one wheel driven by an electric machine, and at least one non-driven wheel, and means for coupling said propulsion system to said rolling object. Said coupling means comprise means for gripping and lifting at least one wheel of said rolling object. Besides, the system comprises a seating device, said seating device comprising a seat and a backrest. In addition, said seating device is foldable between a deployed position allowing a user to sit and a folded position.

Advantageously, said coupling means comprise means for orienting at least one wheel of said rolling object in a direction forming a non-zero angle with the longitudinal direction of said frame of said propulsion system. Preferably, said coupling means comprise means for orienting at least one wheel of said rolling object in a direction substantially perpendicular to the longitudinal direction of said frame of said propulsion system.

According to an embodiment of the system, said seating device comprises at least one translation means and/or at least one rotation means relative to said frame.

According to a configuration, said rotation means comprises a connecting pin of direction substantially perpendicular to the longitudinal direction of said frame, said connecting pin being positioned at the junction between said backrest and said seat.

Advantageously, said translation means comprises at least one substantially vertical slideway.

According to an implementation of the system, when said seating device is deployed, said seat is substantially horizontal and said backrest is substantially vertical.

According to a configuration, when said seating device is folded, said backrest and said seat are substantially horizontal.

According to an advantageous variant, said folded seating device is configured to support a user in a standing position.

According to another variant, when said seating device is folded, said backrest and said seat are substantially vertical.

Preferably, said seating device comprises at least two armrests, said armrests comprising each at least a first part and a second part, preferably said first part being connected by a first pivot connection to said seat, said second part being connected by a second pivot connection to said backrest, and said first and second parts being connected by a third pivot connection.

Preferably, said system comprises at least one toe clip, said toe clip being preferably foldable.

The invention also relates to a method for deploying/folding a seating device of a system according to one of the features described above wherein, in order to deploy the seating device, at least one rotation and/or translation of said seating device is performed, folding of said seating device is achieved by carrying out the steps of deploying said seating device in the reverse order.

Preferably, to deploy said seating device, at least the following step is carried out:
performing a rotation of said seat or of said backrest, relative to said backrest or to said seat respectively, the rotation preferably ranging between 80° and 120°, and being preferably stopped when said seat is substantially horizontal or when said backrest is substantially vertical.

Advantageously, to deploy said seating device, at least the following step is carried out:
performing an upward vertical translation of said seating device, said backrest and said seat being folded and in substantially vertical initial positions, and the rotation and vertical translation steps can be carried out successively or simultaneously.

According to a variant of the method, before or after the step of respective rotation between said seat and said backrest, a rotation of said deployed or folded seating device of about 90° is performed around a substantially horizontal axis in order to position said seating device.

According to an embodiment of the method, to deploy said seating device, at least the following steps are carried out:
performing an upward vertical translation of said connecting pin, said backrest and said seat being folded, in substantially horizontal initial positions and in substantially vertical final positions,
performing a rotation, about said connecting pin, of said seat or said backrest, relative to said backrest or said seat respectively,
performing a rotation of said seating device of about 90° around said connecting pin in order to position said seating device.

According to another embodiment of the invention, to deploy said seating device, at least the following steps are carried out:
performing a rotation of said backrest, relative to said seat respectively, the rotation preferably ranging between 80° and 120°, and being preferably stopped when said backrest is substantially vertical, said backrest and said seat being initially folded and in substantially horizontal initial positions,
performing an upward vertical translation of said seating device in order to position said seating device.

The invention further relates to a coupled assembly comprising a rolling object and an electric propulsion system according to one of the above features, said rolling object being coupled to said electric propulsion system by said coupling means.

### BRIEF DESCRIPTION OF THE FIGURES

Other features and advantages of the system and of the method according to the invention will be clear from reading the description hereafter of embodiments given by way of non-limitative example, with reference to the accompanying figures wherein:

FIG. 1 is a top view of an electric propulsion system according to an embodiment of the invention,

FIG. 2 is a side view of an electric propulsion system according to a first variant embodiment of the invention,

FIG. 3 is a top view of an electric propulsion system according to an embodiment coupled to a rolling object,

FIG. 4 is a side view of an electric propulsion system according to a second variant embodiment of the invention,

FIG. 5 is a side view of an electric propulsion system according to an embodiment of the invention for a user travelling with an electric scooter,

FIG. 6 shows a first embodiment of the seating device deployment method according to the invention,

FIG. 7 shows a second embodiment of the seating device deployment method according to the invention,

FIG. 8 shows a third embodiment of the seating device deployment method according to the invention,

FIG. 9 shows a fourth embodiment of the seating device deployment method according to the invention, and

FIG. 10 is a top view of an electric propulsion system according to an embodiment coupled to a rolling object, with the major part of the electric propulsion system beneath the rolling object.

### DETAILED DESCRIPTION OF THE INVENTION

The present invention relates to an electric propulsion system for a rolling object. An electric propulsion system is understood to be a removable system for assisting the movement of the rolling object in order to limit the forces required for displacement of the rolling object. This electric propulsion system comprises at least one electric machine for driving it. A rolling object is an object comprising at least two wheels in order to move it.

The rolling object can have any form, it can notably be a rolling bed, in particular such as those used in hospitals, a wheelchair, a trolley, such as those used for logistics, hospital logistics or commercial logistics (such as a shopping trolley) for example, any rolling furniture. Such a rolling object comprises at least two wheels, preferably three or four. Advantageously, at least one wheel, preferably two wheels of the rolling object are idle wheels, in other words, off-centered wheels orientable around a vertical axis. The rolling object is preferably non-motorized.

The electric propulsion system according to the invention comprises:
a frame provided with at least one motorized wheel, i.e. a wheel driven by an electric machine, and at least one non-motorized wheel, preferably two, i.e. not driven by an electric machine,
means for coupling the propulsion system to a rolling object, the coupling means comprise means for gripping and lifting at least one wheel, preferably more wheels of the rolling object, and more preferably two wheels of the rolling object, in other words, the coupling means are configured to grip (grab) and lift at least one wheel of the rolling object.

Preferably, the electric propulsion system can comprise a handlebar enabling handling, displacement and orientation of the electric propulsion system by a user.

Coupling the rolling object to the propulsion system is achieved by at least one wheel of the rolling object, preferably at least one idle wheel of the rolling object. Therefore, the rolling object does not need to be adapted for the electric propulsion system, which makes the electric propulsion system universal for various rolling objects.

In the rest of the description, the terms “longitudinal”, “transverse”, “horizontal” and “vertical” determine the axes and/or directions of the system when the system rests on a flat and level floor (i.e. a floor with no slope, in other words, there is no difference in altitude on the floor) and is in operation.

The longitudinal direction corresponds to the principal direction of displacement of the electric propulsion system.

The transverse direction is the orthogonal direction to the longitudinal direction of the system in the horizontal plane.

The vertical direction is orthogonal to the horizontal plane of the system.

The means for gripping the wheel of the rolling object allow the wheel to be grabbed. For example, these gripping means can comprise a clamp system, a wedging system, magnetic means, adhesive means or any similar system. Advantageously, the gripping means can be movable so as to adapt to any wheel dimension and any wheel track. Movement of the gripping means can be achieved by means of one or more cylinders, for example electric cylinders, screw-nut systems, rack and pinion systems, or any similar means.

The means for lifting the wheel allow the wheel of the rolling object to be elevated, so that this wheel of the rolling object no longer touches the floor, thus facilitating displacement of the rolling object by the electric propulsion system. The mass of the rolling object supported by this wheel is then transferred to the electric propulsion system. This notably provides the adhesion required for the motivity of the motorized wheel of the electric propulsion system. Lifting can be achieved by means of one or more cylinders, for example electric cylinders, screw-nut systems, rack and pinion systems, or any similar means.

According to the invention, the system also comprises a seating device including at least a backrest and a seat, the seating device being foldable between a deployed position allowing a user to sit and a folded position (that does not allow a user to sit). The seating device can notably be intended fora patient. In other words, the seating device can comprise at least one seating device deployment/folding means for deploying and folding it. This foldable seating device is particularly advantageous for the user, a stretcher-bearer for example, who can then rapidly and efficiently adapt to the situation they are facing. For example, when the stretcher-bearer had not initially planned to transport the patient in a sitting position but it appears that this position is finally necessary for transporting the patient, they can deploy the seating device without having to look for an available wheelchair. The result is reduced intervention time and improved service. According to another use, the stretcher-bearer may be called to transport a patient in sitting position on the propulsion system, the seating device being then intended to be used in deployed position, but the medical situation upon arrival of the stretcher-bearer may have changed, thus requiring the patient to be transported in horizontal position on the hospital bed. In this case, the stretcher-bearer can rapidly fold the seating device and couple the bed to the propulsion system so as to transport the patient. Thus, integration of a foldable seating device to the propulsion system enables better adaptation of the user, the stretcher-bearer for example, to the situation they are facing in real time. It also provides greater efficiency and increased speed of intervention of the user, the stretcher-bearer for example, thus improving the service provided by the user.

In unfolded position, the seating device can also allow transport of some materials placed on the seat.

According to an embodiment of the invention, in folded position, the seat and the backrest of the seating device can be positioned beside one another so as to reduce the space requirement thereof in folded position. For example, the bearing surfaces (against which a user rests) can be in contact in folded position. In other words, the backrest can form an angle close to 0° relative to the seat in folded position. Alternatively, the seat and the backrest of the seating device can form a plane surface when positioned side by side in folded position; in other words, the backrest can form a 180° angle relative to the seat.

Furthermore, in folded position, the seating device is compact and it does not hinder gripping of the wheels of the rolling object, which allows the propulsion system to be readily adaptable to various rolling objects.

According to an implementation of the invention, the seating device (in folded position and in unfolded position) is arranged longitudinally between the motorized wheel and the non-motorized wheels. Thus, the longitudinal size of the removable propulsion system remains limited and it is not affected by the presence of the seating device.

Advantageously, the coupling means can comprise means for orienting at least one wheel of the rolling object, referred to as gripped (by the gripping means) wheel, in a direction forming a non-zero angle with the longitudinal direction of the propulsion system frame, for example the angle between the orientation of the gripped wheel and the longitudinal direction of the frame can be at least 10°. Orienting the wheel of the rolling object in a direction forming a non-zero angle with the longitudinal direction ensures that the rolling object is maintained in longitudinal position relative to the propulsion system. In other words, a relative longitudinal displacement between the coupled rolling object and the propulsion system is thus prevented. Preferably, the coupling means can comprise means for orienting the gripped wheel in a direction substantially perpendicular to the longitudinal direction of the propulsion system frame (in other words, the wheel of the rolling object is arranged in a position that is parallel or substantially parallel to the lateral direction of the frame). The longitudinal direction of the frame is defined by the direction connecting the motorized wheel to the non-motorized wheel. The longitudinal direction corresponds to the principal direction of displacement of the electric propulsion system. A substantially perpendicular direction is understood to be a direction forming an angle ranging between 80° and 100° relative to the longitudinal direction. Thus, upon propulsion of the rolling object, at least one wheel of the rolling object is gripped, lifted and oriented in a different direction to the longitudinal direction of the frame (for example with an angle greater than 10° between the orientation of the gripped wheel and the longitudinal direction of the frame), for example substantially perpendicular to the longitudinal direction of the frame. By orienting at least one wheel of the rolling object in a different direction to the longitudinal direction of the frame, preferably the angle thus formed being greater than 10° and more preferably close to 90°, the stability of the coupled assembly made up of the rolling object on the propulsion system is improved. In addition, the coupling means thus act on the least thick side of the wheels of the rolling object. This contributes to ensuring that the coupling means have reduced lateral dimensions in relation to the lateral dimensions of the propulsion systems of the prior art (as described for example in patent applications WO-2012/171,079 and WO-2013/156,030), which facilitates their use in reduced spaces such as corridors and lifts. The means of orienting the wheel of the rolling object can be implemented through the displacement of the wheel gripping means. According to an implementation of the invention, the electric propulsion system can perform the following sequence of steps for coupling: orienting the wheel of the rolling object in a different direction to the longitudinal direction of the frame, gripping the wheel of the rolling object and lifting the wheel of the rolling object.

According to an embodiment of the invention, the electric propulsion system can be configured in such a way that the non-motorized wheel(s) are located beneath the rolling object when the electric propulsion system is coupled to the rolling object. Thus, a part of the electric propulsion system does not protrude from the rolling object, which facilitates its use in reduced spaces.

Preferably, the propulsion system can be configured in such a way that the major part of the propulsion system is located beneath the rolling object when the propulsion system is coupled to the rolling object. Only the part of the frame corresponding to the motorized wheel and/or the optional handlebar protrude from the rolling object in the longitudinal direction of the frame.

According to an embodiment, the propulsion system can comprise three or four wheels. When the propulsion system has three wheels, a single wheel can be driven by an electric machine. When the propulsion system has four wheels, two wheels can be driven by an electric machine.

According to an implementation of the invention, the motorized wheel can be arranged at one longitudinal end of the frame and the non-motorized wheels can be arranged at the other longitudinal end of the frame.

According to a preferred embodiment, the coupling means can be connected to the frame between the motorized wheel and the non-motorized wheel(s). Thus, the longitudinal size of the propulsion system is limited.

The electric propulsion system can further comprise an electric battery for powering the electric machine. The electric battery can be arranged on or beneath the frame, for example at the longitudinal end of the frame close to the motorized wheel, or at the longitudinal end of the frame close to the non-motorized wheels. Alternatively, the battery can be arranged on the handlebar. Furthermore, the battery can be removable so as to facilitate charging or replacement thereof. Alternatively, the battery may not be removable.

According to an implementation of the invention, the non-motorized wheels can be idle wheels, i.e. off-centered wheels orientable around a vertical axis. In other words, the non-motorized wheels can pivot with respect to the frame about a vertical orientation axis, and the orientation axis of the wheel can be off-centered (non-concurrent) with respect to the vertical orientation axis.

Alternatively, the non-motorized wheels can be wheels orientable around a vertical axis in a non-off-centered manner. In other words, the non-motorized wheels can pivot with respect to the frame about a vertical orientation axis, and the rotation axis of the wheel is aligned with this vertical orientation axis (concurrent with the vertical orientation axis).

Advantageously, the seating device can comprise at least one translation means and/or rotation means relative to the frame. These rotation and translation means allow deployment/folding of the seating device.

The translation means can be a means providing vertical translation of the unfolded and/or folded seating device, such as a slideway. Vertical translation makes it possible to position the seat in a first position for transporting a person in seated position and in another position when it is folded so as to limit the overall size thereof. In addition, vertical translation allows to position the seat at such a height that the feet of the seated person cannot rest on the floor (in other words, the vertical position of the seat can be adapted to the height of the transported person), and thus ensures the comfort of the person sitting on the seat.

The rotation means can allow rotation of the seating device of about 90° (between 80° and 100°) in unfolded position and/or in folded position. This rotation means notably provides a comfortable unfolded position for the user and it allows the folded seating device to be positioned in a location where its overall size hinders as little as possible the use of the propulsion system, notably when it is coupled to a rolling object.

It may also be a rotation means providing relative rotation of the backrest and of the seat of the seating device so as to switch from the unfolded position to the folded position of the seating device, and vice versa. The unfolded position allows transport of a person in a sitting position, and possibly transport of material. The folded position, notably when the seat and the backrest are folded on one another, provides a reduced space requirement when the propulsion system is coupled to a rolling object. The relative rotation between the backrest and the seat can range between 80° and 120°, thus enabling switching from the unfolded position to the folded position (and vice versa), in a comfortable position for the user in sitting position.

According to a preferred embodiment of the invention, the seating device can comprise at least one vertical translation means and at least one relative rotation means between the backrest and the seat. Thus, the seating device can be readily unfolded/folded and positioned vertically at an altitude for transport of persons in unfolded position and in order to reduce its height in folded position.

According to an alternative, the seating device can comprise a rotation means for the seating device in unfolded or folded position and a relative rotation means for the seat and the backrest of the seating device. Thus, the seating device can be unfolded/folded and positioned in a comfortable position for the transported person, while providing reduced space requirement when the seating device is not used.

When the seating device comprise a relative rotation means for the seat and the backrest, the possible angular rotation between the seat and the backrest can preferably be about 90° (between 80° and 120°), so as to enable switching from the folded position to the unfolded position. In folded position, preferably, the seat and the backrest are folded on one another (the angle formed between the seat and the backrest is substantially zero) so as to reduce as much as possible the space occupied by the seating device. In unfolded position, an angle close to 90° between the seat and the backrest provides comfort to the person transported in seated position. Preferably, the angle between the backrest and the seat can be set to between 80° and 120° so as to provide optimum comfort to the transported person, notably depending on their condition.

According to an implementation of the invention, the rotation means can comprise a connecting pin of direction substantially perpendicular to the longitudinal direction of the frame (along the transverse axis), i.e. in a substantially transverse direction of the frame, the connecting pin being positioned at the junction between the backrest and the seat. Thus, the connecting pin can act as a rotation axis between the backrest and the seat. In addition, the junction between the backrest and the seat can be in an area close to an end of the seat and in an area close to an end of the backrest. Thus, rotation of the seat and of the backrest about the connecting pin can provide a folded position where the seat and the backrest are folded on one another, i.e. a position where a face of the seat and a face of the backrest are in contact (or substantially in contact). Thus, deployment/folding of the seating device is simple and easy, and the space requirement in folded position is reduced.

Besides, the connecting pin being in a perpendicular direction to the longitudinal axis of the frame (along the transverse axis of the frame), the position of the seating device in unfolded position enables transport of a person oriented in the longitudinal direction. What is understood by a person oriented in the longitudinal direction is that the direction of the eyes (direction of the field of view) is longitudinal when the person's head is oriented along the axis of the body (i.e. not twisted with respect to the axis of the body, the spine is not twisted). Thus, the person is transported in the (longitudinal) direction of displacement. This makes it easier to accommodate the person in the seat of the seating device, it enables the transported person to better see the direction of displacement and it also allows to better balance the transported load in relation to an orientation of the connecting pin in the longitudinal direction of the frame.

According to an embodiment of the invention, the translation means can comprise at least one vertical slideway. The vertical slideway provides a vertical movement in a simple and inexpensive manner.

Advantageously, when the seating device is deployed, the seat can be substantially horizontal (the average angle between the seat that may not be plane and the horizontal plane ranges for example between −10° and +10°), and the backrest can be substantially vertical (the average angle between the backrest that may not be plane and the vertical plane ranges for example between −10° and +20°). The term average angle means that the backrest and the seat may not be plane so as to improve the transported person's comfort, for example the backrest has substantially the shape of the spine that is bent, therefore the average plane of the backrest or of the seat is considered to define the average angle. A substantially horizontal seat provides a stable seated position of the transported person (or load). A vertical backrest further improves the stability of the transported person (or load), and the seating comfort of the person is also increased.

According to a configuration of the invention, when the seating device is folded, the backrest and the seat can be substantially horizontal (for example, the average angle between the backrest or the seat (which may not be plane) and the horizontal plane ranges between −10° and +10°). Therefore, the backrest and the seat can be located just above the frame, which allows to limit the longitudinal size of the system when it is coupled to a rolling object. Preferably, the backrest and the seat are positioned vertically above one another in folded position.

Advantageously, the folded seating device, with the substantially horizontal backrest and seat, can be configured to support a user in a standing position. Indeed, when they are horizontally positioned, the folded configuration with the horizontal axis can be dimensioned to support the weight of at least one standing user (in a vertical position). Thus, the system with the folded seating device can be used in scooter mode to transport at least one user in vertical position, the handlebar being then used for orienting the propulsion system.

According to an alternative of the invention, when the seating device is folded, the backrest and the seat can be substantially vertical. Therefore, the space requirement in the horizontal plane, longitudinal for example, of the seating device is limited.

According to an advantageous implementation of the invention, the seating device can comprise at least two armrests, each armrest comprising at least a first part and a second part. Preferably, the first part can be connected to the seat by a first pivot connection and the second part can be connected to the backrest by a second pivot connection. Furthermore, according to this preferred implementation, the first part and the second part can be connected by a third pivot connection (by a pin acting as a joint for example), so as to enable relative rotation thereof. These joints (pivot connections) allow to unfold/fold the armrests, simultaneously with the deployment/folding of the seating device, automatically. Thus, the folded armrests have reduced space requirement. Using armrests increases the comfort of the transported person and improves their posture in sitting position on the unfolded sitting device.

According to a variant of the invention, the system can comprise at least one toe clip. The toe clip allows the feet of the transported person to be positioned during transport. A single toe clip can be used to position both feet or two distinct toe clips can be used, one for each foot.

Preferably, the toe clip is foldable so as to limit the space used by the toe clip when it is not in use. According to an alternative, the top clip can be removed so as to further limit the space used when it is not in use.

According to an embodiment of the invention, the propulsion system can further comprise at least one stop for holding the seating device in deployed position or in folded position. For example, the translation means and/or the rotation means of the seating device can comprise at least one stop at one end of the translational movement and/or of the rotational movement.

The invention also relates to a method for deploying/folding a seating device of a propulsion system as described above wherein, to deploy the seating device, at least one rotation and/or translation of the seating device is performed, and folding of the seating device is achieved by carrying out the steps of deploying the seating device in the reverse order. For example, to deploy the seating device, at least one step of vertical translation of the complete seating device, of the backrest, the seat or the connecting pin can be carried out. Alternatively or in combination, it is also possible to perform a relative rotation of the backrest and of the seat to deploy the system relative to the connecting pin for example, and/or to perform a rotation of the seating device in unfolded or folded position. Thus, the seating device can be unfolded/folded and judiciously positioned to limit the space requirement.

According to a first implementation of the method of the invention, to deploy the seating device, at least the following step can be carried out:
performing a rotation of the seat relative to the backrest (or vice versa, a rotation of the backrest relative to the seat) so as to deploy the seating device. The rotation can range between 80° and 120°, and it is preferably stopped when the seat is substantially horizontal and/or when the backrest is substantially vertical, i.e. when the position of the seating device is deployed, thus allowing a person to sit on the seat and to rest their back against the backrest of the seating device. A reverse rotation allows the seating device to be folded, thus limiting the space occupied by the seating device in folded position.

According to a second implementation of the method of the invention that may be or not combined with the first implementation described above, to deploy the seating device, at least the following step can also be carried out:
performing an upward vertical translation of the seating device. For example, the backrest and the seat can be folded one against the other and, for example, in substantially vertical initial positions. Thus, the backrest can for example be moved into its deployed final position. According to another example, the backrest and the seat can be folded one against the other and in substantially horizontal initial positions. Thus, the seat can be moved into its deployed final position. According to another example, the backrest and the seat can be moved vertically in unfolded position so as to position the seating device in a position enabling a person to sit.

The vertical translation can be carried out before the rotation, after the rotation or simultaneously with the rotation.

According to a variant of the method of the invention, before, after or simultaneously with the step of respective rotation between the seat and the backrest, a rotation of the deployed or folded seating device of about 90° can also be performed around a substantially horizontal axis in order to position the seating device. This rotation can allow the seating device to be positioned in its position of use.

According to a third implementation of the method of the invention, to deploy the seating device, at least the following steps can be carried out:
performing an upward vertical translation of the connecting pin, the backrest and the seat being folded, in substantially horizontal initial positions, resting on the frame for example, and in substantially vertical final positions; thus, the vertical displacement of the connecting pin causes rotation of the backrest and of the seat around the connecting pin, until the backrest and the seat are substantially vertical (by gravity). The backrest and the seat are then suspended by the connecting pin,
performing a rotation, about the connecting pin, of the seat or the backrest, relative to the backrest or to the seat respectively, so as to switch from a position where the seat and the backrest are against one another to an “open” position, i.e. forming an angle between the seat and the backrest. The rotation is preferably of the order of 90°, between 80° and 120° for example,
performing a rotation of the seating device of about 90° around the connecting pin in order to position the seating device. This rotation can be performed before or after the relative rotation of the backrest and the seat. When it is performed after, the rotation of the seating device is performed in deployed position. In the opposite case, the rotation of the seating device is performed in folded position.

According to a fourth implementation of the method of the invention, to deploy the seating device, at least the following steps can be carried out:
performing a rotation of the backrest, relative to the seat respectively, the rotation being preferably stopped when said backrest is substantially vertical, said backrest and said seat being initially folded and in substantially horizontal initial positions, resting on the frame for example; it is thus possible to switch from a position where the backrest and the seat are against one other to an “open” position where an angle close to 90° for example is formed between the backrest and the seat,
performing an upward vertical translation of the seating device in order to position the seating device. The translation can be performed before or after the relative rotation of the backrest and the seat. When it is performed after, the translation of the seating device is performed in deployed position. In the opposite case, the translation of the seating device is performed in folded position.

The invention further relates to a coupled assembly comprising a rolling object, such as a rolling bed, and a propulsion system according to one of the above variant combinations. The rolling object is coupled to the propulsion system by the coupling means.

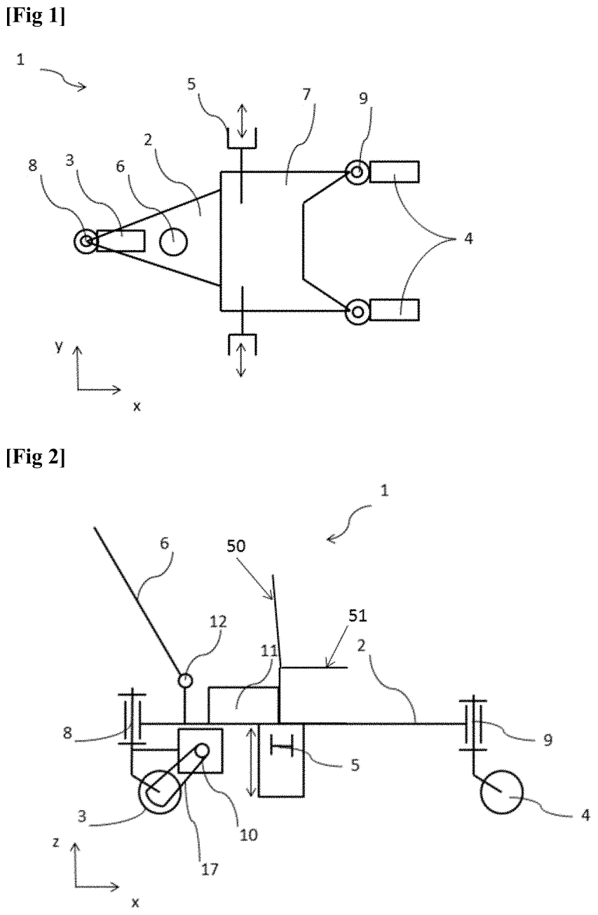

FIG. 1 schematically illustrates, by way of non-limitative example, an electric propulsion system according to an embodiment of the invention. FIG. 1 is a top view of electric propulsion system 1. Electric propulsion system 1 comprises a frame 2. Axis x corresponds to the longitudinal axis of frame 2 and to the principal direction of displacement of propulsion system 1, and axis y corresponds to the lateral axis of frame 2. Frame 2 supports three wheels (alternatively, frame 2 can comprise four wheels). Frame 2 supports a wheel 3 (alternatively, frame 2 can support two wheels 3), which is a wheel driven by an electric machine (not shown). Wheel 3 is orientable relative to frame 2, around a vertical axis 8. At the other end, frame 2 supports two wheels 4, which are not driven by an electric machine. Wheels 4 are orientable relative to the frame around vertical axes 9 (wheels 4 can have a directional lock). Each wheel, driven or not, is thus orientable around a vertical axis. Electric propulsion system 1 further comprises coupling means 5. According to the embodiment illustrated, electric propulsion system 1 comprises two coupling means 5, on either side of the frame along the lateral direction (axis y) so as to provide coupling by means of two wheels of the rolling object (not shown). Coupling means 5 are shown in a simplified manner as clamps. The lateral motion of the coupling means is shown by a double arrow. This lateral motion can serve for gripping and orienting the wheels of the rolling object, and for adaptation to various rolling objects, notably different track widths of the rolling object wheels to be gripped. Coupling means 5 are arranged, in direction x, between motorized wheel 3 and non-motorized wheels 4. Furthermore, electric propulsion system 1 comprises a handlebar 6, for example in form of a rod equipped with a handle (not shown) articulated with respect to frame 2. Besides, electric propulsion system 1 comprises a supporting platform 7 (for supporting a user for example). Platform 7 is arranged at the end of frame 2 supporting non-motorized wheels 4.

FIG. 2 schematically illustrates, by way of non-limitative example, an electric propulsion system according to a first variant embodiment of the invention. FIG. 2 is a side view of electric propulsion system 1. Electric propulsion system 1 comprises a frame 2. Axis x corresponds to the longitudinal axis of frame 2 and to the principal direction of travel of the propulsion system, and axis z corresponds to the vertical axis of frame 2. The frame supports three wheels. Frame 2 supports a wheel 3, which is driven by an electric machine 10 by means of a drive 17 such as a belt or a chain for example (alternatively, electric machine 10 can be directly connected to wheel 3). Wheel 3 is orientable relative to frame 2, around a vertical axis 8. Electric machine 10 can interact with pivot 8 of motorized wheel 3. At the other end, frame 2 supports two wheels 4, which are two wheels that are not driven by an electric machine. Wheels 4 are orientable relative to the frame around vertical axes 9 (wheels 4 can have a directional lock). Electric propulsion system 1 further comprises coupling means 5. According to the embodiment illustrated, electric propulsion system 1 comprises two coupling means 5, on either side of the frame in the lateral direction (axis y orthogonal to vertical axis z and to longitudinal axis x) so as to provide coupling by means of two wheels of the rolling object (not shown). Coupling means 5 are shown in a simplified manner as clamps. The vertical motion of coupling means 5 is shown by a double arrow. This vertical motion of coupling means 5 notably allows lifting of the rolling object wheels. Coupling means 5 are arranged, in direction x, between motorized wheel 3 and non-motorized wheels 4. Furthermore, electric propulsion system 1 comprises a handlebar 6, for example in form of a rod equipped with a handle (not shown) articulated with respect to frame 2 by means of a joint 12 of horizontal axis, in the lateral direction of frame 2 (perpendicular to the plane of the figure). Besides, electric propulsion system 1 comprises a battery 11. Battery 11 is arranged on frame 2 close to electric machine 10 and motorized wheel 3.

Electric propulsion system 1 also comprises a seating device shown in unfolded (deployed) position. The seating device comprises a backrest 50 and a seat 51. Seat 51 in unfolded position is substantially horizontal. In FIG. 2, backrest 50 is in a substantially vertical direction, the angle formed between seat 51 and backrest 50 is close to 90°, about 100° here. When the user sits on the seating device, they are oriented in direction x: when their head is oriented along the axis of the body (the head is not twisted with respect to the body), the user looks in the direction of displacement x.

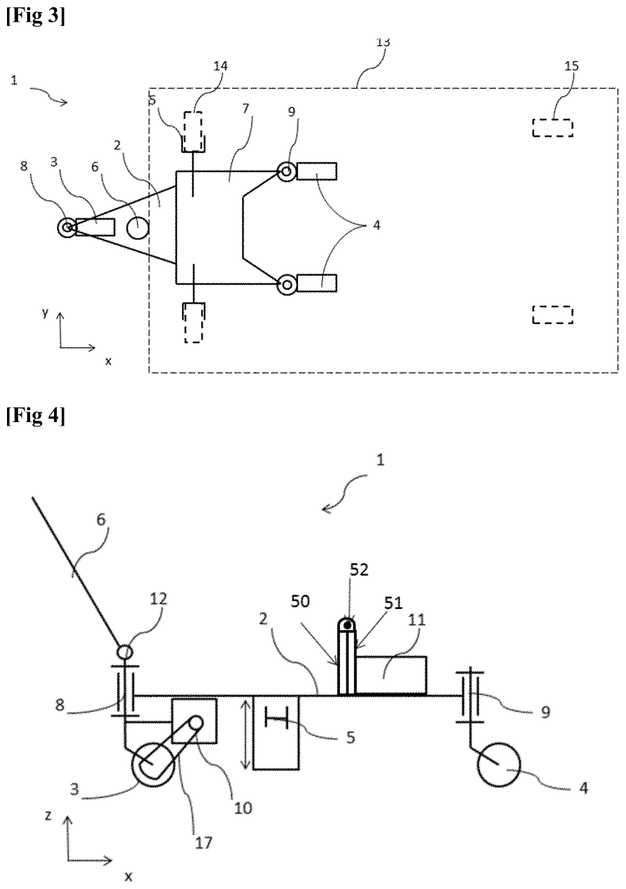

FIG. 3 schematically illustrates, by way of non-limitative example, an electric propulsion system according to an embodiment of the invention coupled to a rolling object 13. FIG. 3 is a top view of electric propulsion system 1 and of rolling object 13. The embodiment of FIG. 3 corresponds to the embodiment of FIG. 1. Rolling object 13 can be of any type, notably a rolling bed. The rolling object comprises two wheels 14, arbitrarily referred to as rear wheels, and two wheels 15, arbitrarily referred to as front wheels. Electric propulsion system 1 comprises a frame 2. Axis x corresponds to the longitudinal axis of frame 2 and to the principal direction of displacement of the propulsion system, and axis y corresponds to the lateral axis of frame 2. The frame supports three wheels. Frame 2 supports a wheel 3, which is a wheel driven by an electric machine (not shown). Wheel 3 is orientable with respect to frame 2, around a vertical axis 8. At the other end, frame 2 supports two wheels 4, which are two wheels that are not driven by an electric machine. Wheels 4 are orientable with respect to the frame around vertical axes 9 (wheels 4 can have a directional lock). Electric propulsion system 1 further comprises coupling means 5. According to the embodiment illustrated, electric propulsion system 1 comprises two coupling means 5 on either side of the frame in the lateral direction (axis y) in order to achieve coupling by means of two rear wheels 14 of the rolling object. Coupling means 5 are shown in a simplified manner as clamps. Rear wheels 14 of the rolling object are arranged in the clamp and substantially oriented along axis y, i.e. an axis substantially perpendicular to the longitudinal axis (axis x) of frame 2. Furthermore, front wheels 15 of the rolling object are free and not coupled. Electric propulsion system 1 also comprises a handlebar 6, for example in form of a rod equipped with a handle (not shown) articulated with respect to frame 2. Besides, electric propulsion system 1 comprises a supporting platform 7 (for supporting a user for example). Platform 7 is arranged at the end of frame 2 supporting non-motorized wheels 4. For the embodiment of FIG. 3, coupling means 5, non-motorized wheels 4, platform 7 and a major part of frame 2 are located beneath the rolling object. Only motorized wheel 3 and handlebar 6 can protrude from rolling object 13 in the longitudinal direction x of frame 2.

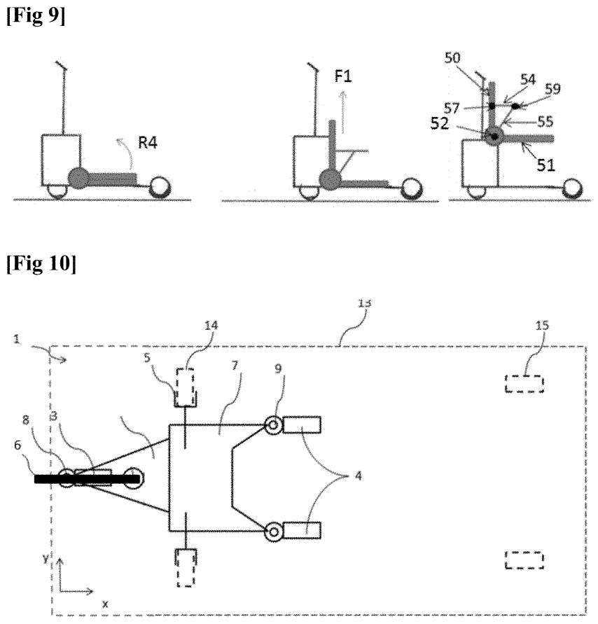

FIG. 10 is a non-limitative variant of FIG. 3. The references corresponding to those of FIG. 3 correspond to the same elements and will therefore not be described again.

FIG. 10 differs from FIG. 3 in that electric propulsion system 1 is essentially positioned beneath rolling object 13, a rolling bed for example. In other words, the major part of electric propulsion system 1 is beneath rolling object 13 when the electric propulsion system is coupled to rolling object 13. Indeed, in this figure, only a small part of handlebar 6 protrudes longitudinally from rolling object 13, materialized by dotted lines. Thus, the longitudinal and transverse space requirement of electric propulsion system 1 coupled to rolling object 13 is limited.

FIG. 4 schematically illustrates, by way of non-limitative example, an electric propulsion system 1 according to a second variant embodiment of the invention. FIG. 4 is a side view of electric propulsion system 1. Electric propulsion system 1 comprises a frame 2. Axis x corresponds to the longitudinal axis of frame 2 and to the principal direction of displacement of the propulsion system, and axis z corresponds to the vertical axis of frame 2. The frame supports three wheels. Frame 2 supports a wheel 3, which is a wheel driven by an electric machine 10 by means of a drive 17 such as a belt or a chain for example. Wheel 3 is orientable relative to frame 2, around a vertical axis 8. Electric machine 10 can interact with pivot 8 of motorized wheel 3. At the other end, frame 2 supports two wheels 4, which are two wheels that are not driven by an electric machine. Wheels 4 are orientable relative to frame 2 around vertical axes 9 (wheels 4 can have a directional lock). Electric propulsion system 1 further comprises coupling means 5. According to the embodiment illustrated, electric propulsion system 1 comprises two coupling means 5, on either side of frame 2 in the lateral direction (axis y orthogonal to vertical axis z and to longitudinal axis x) so as to provide coupling by means of two wheels of the rolling object (not shown). Coupling means 5 are shown in a simplified manner as clamps. The vertical motion of coupling means 5 is shown by a double arrow. This vertical motion of the coupling means notably allows lifting of the rolling object wheels. Coupling means 5 are arranged, in direction x, between motorized wheel 3 and non-motorized wheels 4. Furthermore, electric propulsion system 1 comprises a handlebar 6, for example in form of a rod equipped with a handle (not shown) articulated with respect to vertical orientation axis 8 of motorized wheel 3 by means of a joint 12 of horizontal axis, parallel to the axis of rotation of the motorized wheel. Besides, electric propulsion system 1 comprises a battery 11. Battery 11 is arranged on frame 2 close to non-motorized wheels 4.

In this figure, the electric propulsion system comprises a seating device with a backrest 50 and a seat 51 in folded position. Here, by way of non-limitative example, the folded position corresponds to a position where seat 51 and backrest 50 are folded against one another face to face, in other words, a face of backrest 50 is substantially in contact with a face of seat 51, and in vertical positions. Deployment/folding of seat 51 relative to backrest 50 can notably be achieved through a joint 52 with, for example, a connecting pin around which a relative rotation of backrest 50 and of seat 51 can be performed. In other words, backrest 50 and seat 51 are connected by a pivot connection around an axis corresponding to joint 52.

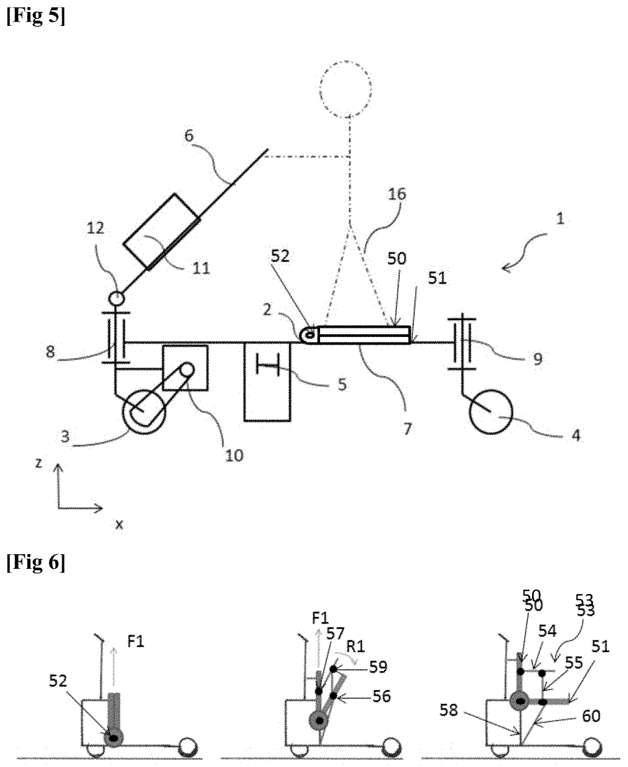

FIG. 5 schematically illustrates, by way of non-limitative example, an electric propulsion system 1 according to the first variant embodiment of the invention, electric propulsion system 1 being used as a scooter by a user 16. FIG. 5 is a side view of propulsion system 1. The propulsion system of FIG. 5 substantially corresponds to the propulsion system of FIG. 3. Electric propulsion system 1 comprises a frame 2. Axis x corresponds to the longitudinal axis of frame 2 and to the principal direction of displacement of the propulsion system, and axis z corresponds to the vertical axis of frame 2. The frame supports three wheels. Frame 2 supports a wheel 3, which is a wheel driven by an electric machine 10 by means of a drive, a belt or a chain for example. Wheel 3 is orientable with respect to frame 2, around a vertical axis 8. Electric machine 10 can interact with pivot 8 of motorized wheel 3. At the other end, frame 2 supports two wheels 4, which are two wheels that are not driven by an electric machine. Wheels 4 are orientable with respect to the frame, around vertical axes 9 (wheels 4 can have a directional lock). Electric propulsion system 1 further comprises coupling means 5. According to the embodiment illustrated, electric propulsion system 1 comprises two coupling means 5 on either side of frame 2 in the lateral direction (axis y orthogonal to longitudinal axis x and to vertical axis z) in order to achieve coupling by means of two wheels of the rolling object (not shown). Coupling means 5 are shown in a simplified manner as clamps. Coupling means 5 are arranged, in direction x, between motorized wheel 3 and non-motorized wheels 4. Furthermore, electric propulsion system 1 comprises a handlebar 6, for example in form of a rod equipped with a handle (not shown) articulated with respect to frame 2 by means of a joint 12 of horizontal axis, parallel to the rotation axis of the motorized wheel. Besides, electric propulsion system 1 comprises a battery 11. Battery 11 is arranged on handlebar 6. Frame 2 comprises, at the longitudinal end thereof close to non-motorized wheels 4, a platform 7.

In this figure, the electric propulsion system comprises a seating device with a backrest 50 and a seat 51 in folded position. Here, by way of non-limitative example, the folded position corresponds to a position where seat 51 and backrest 50 are folded against one another face to face, in other words, a face of backrest 50 is substantially in contact with a face of seat 51, and in horizontal positions. Deployment/folding of seat 51 relative to backrest 50 can notably be achieved through a joint 52 with, for example, a connecting pin around which a relative rotation of backrest 50 and of seat 51 can be performed. In other words, backrest 50 and seat 51 are connected by a pivot connection around an axis corresponding to joint 52, of substantially transverse axis. In order to allow positioning of the unfolded seating device at a vertical height enabling the user to sit on the seating device, joint 52 (or backrest 50 and/or seat 51) can be moved along vertical axis z, using a slideway (not shown) for example.

For the illustrated use of the non-coupled electric propulsion system 1, the electric propulsion system is used as a scooter by user 16: the user stands on backrest 50 of the seating device in folded position, seat 51 is then beneath backrest 50 in folded position (alternatively, the user might stand on seat 51, backrest 51 would then be beneath seat 51), and holds and/or actuates handlebar 6 so as to control the propulsion system.

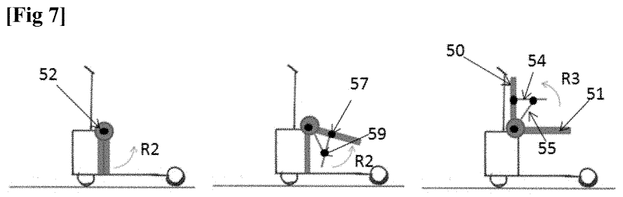

FIG. 6 schematically illustrates, by way of non-limitative example, a first embodiment of the deployment of the system according to the invention. The diagrams from left to right show various steps of the method of deploying the seating device of the invention. In this embodiment, initially, the seating device is in folded position (left-hand diagram), seat 51 and backrest 50 being substantially vertical, against one another, a joint 52 serving for relative rotation between backrest 50 and seat 51 being then positioned vertically beneath backrest 50 and seat 51.

In a first step of deploying the seating device, the folded seating device is moved vertically upward, in a vertical translation, which can be provided by a slideway 58. Arrow F1 represents the motion of the seating device in folded position in vertical translation.

Seat 51 is then lowered whereas backrest 50 remains in vertical position. Lowering of the seat is achieved through a relative rotation R1 of seat 51 relative to backrest 50 that remains stationary, around joint 52 (centre diagram). When seat 51 reaches a substantially horizontal position, rotation R1 is stopped, a stop device can be provided therefore. Thus, in deployed position (right-hand diagram), the seat is substantially horizontal and the backrest is substantially vertical so as to accommodate a user who can sit on the seating device in the direction of displacement of the seating device.

The seating device also comprises two armrests 53, on either side of seat 51, for holding the user (the patient) in position. Each of these armrests 53 comprises a first part 55 and a second part 54 connected by a joint 59 (a pin for example) so as to enable a relative rotation of first part 55 with second part 54. In addition, first part 55 is connected to seat 51 by a pivot connection 56 (a joint, for example a transverse direction pin) and second part 54 is connected to backrest 50 by another pivot connection 57. Thus, upon deployment of the seating device, deployment of armrests 53 is driven by the deployment of seat 51 relative to backrest 50. Upon folding of the seating device, folding of armrests 53 is driven by the folding of seat 51 relative to backrest 50.

The seating device can also comprise a support bar 60 that is deployed simultaneously with the seating device and allows, once the device deployed, to take up the weight of the user sitting on seat 51 so as to ensure higher mechanical resistance of the seating device. Support bar 60 is articulated at one end thereof with seat 51, preferably in the part of seat 51 remote from joint 52 of seat 51 with backrest 50 so as to provide better forces take-up. Support bar 60 is also articulated with the electric propulsion system, at the frame for example, to enable deployment/folding thereof. Preferably, the angle formed by support bar 60 with the vertical ranges between 30° and 70°, and it is preferably about 45°.

In a variant, this support bar 60 can serve for deployment of the assembly. This means that, by translating backrest 50 substantially upwards, the seating device and armrests 53 can be deployed.

Symmetrically, the diagrams from right to left show the various steps of the method of folding the seating device of the invention, by carrying out the steps in reverse order.

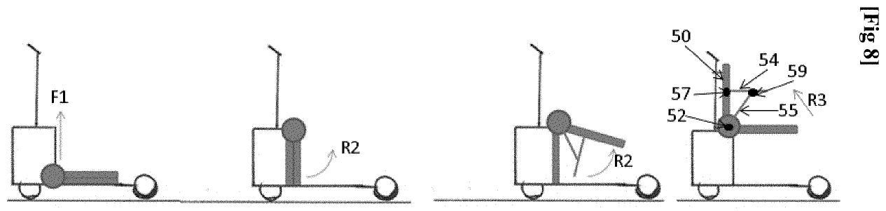

FIG. 7 schematically illustrates, by way of non-limitative example, a second embodiment of the deployment/folding of the system according to the invention. The diagrams from left to right show various steps of the method of deploying the seating device of the invention.

In this embodiment, initially, the seating device is in folded position (left-hand diagram), seat 51 and backrest 50 being substantially vertical, against one another, a joint 52 serving for relative rotation between backrest 50 and seat 51 being then positioned vertically above backrest 50 and seat 51.

In a first step of deploying the seating device, a rotation R2 of backrest 50 is performed relative to seat 51 that remains stationary in its vertical initial position, around joint 52. This rotation R2 is stopped when the backrest is substantially along the horizontal axis, i.e. when the angle formed between backrest 50 and seat 51 is substantially 90°, between 80° and 120° for example.

The seating device then undergoes a rotation R3 around joint 52, of about 90°. During this rotation R3, the angle existing at the end of rotation R2 between seat 51 and backrest 50 remains constant, close to 90°. In other words, rotation R3 drives the deployed seating device and therefore simultaneously concerns seat 51 and backrest 50, without performing a relative rotation between these two elements. When rotation R3 is about 90° around joint 52, seat 51 is substantially horizontal and backrest 50 is substantially vertical. In other words, at the end of rotation R3, the seating device is ready for use.

The seating device also comprises two armrests, on either side of the seat, for holding the user in position. Each of these armrests comprises a first part 55 and a second part 54 connected by a joint 59 (a pin for example) so as to enable a relative rotation of first part 55 with second part 54. In addition, first part 55 is connected to seat 51 by a joint close to and offset from joint 52, and second part 54 is connected to backrest 50 by a pivot connection 57. The offset of the joint between first part 55 and joint 52 enables deployment/folding of the armrests. Thus, upon deployment of the seating device, deployment of the armrests is driven by the deployment of seat 51 relative to backrest 50. Upon folding of the seating device, folding of armrests 53 is driven by the folding of seat 51 relative to backrest 50.

According to a variant, first part 55 could be connected to seat 51 directly by joint 52 (instead of a joint close to and offset from joint 52). In this case, first part 55 and/or second part 54 can comprise extendable arms. Therefore, the length of first part 55 and/or of second part 54 can vary and thus enable deployment/folding of the armrests.

Additionally, according to a non-illustrated variant, the seating device could comprise a support bar if necessary, for taking up part of the user's weight.

Symmetrically, the diagrams from right to left show the various steps of the method of folding the seating device of the invention, by carrying out the steps in reverse order.

FIG. 8 schematically illustrates, by way of non-limitative example, a third embodiment of the deployment/folding of the system according to the invention. The diagrams from left to right show various steps of the method of deploying the seating device of the invention.

In this embodiment, initially, the seating device is in folded position (left-hand diagram), seat 51 and backrest 50 being substantially horizontal, against one another, a joint 52 serving for relative rotation between backrest 50 and seat 51.

In a first step of deploying the seating device, a vertical displacement F1 of joint 52 is performed, by means of a slideway for example. During this vertical displacement of joint 52, seat 51 and backrest 50 rotating freely around joint 52, they are progressively positioned along the vertical axis, while being suspended from joint 52, which is vertically above seat 51 and backrest 50 during vertical displacement F1 of joint 52. At the end of vertical displacement F1 of joint 52, seat 51 and backrest 50 are vertical, against one another, as shown in the second diagram from the left.

Backrest 50 is then deployed whereas seat 51 remains in vertical position. The deployment of backrest 50 is provided by a relative rotation R2 of backrest 50 relative to seat 51 that remains stationary, around joint 52 (third figure from the left). When backrest 50 reaches a substantially horizontal position, rotation R2 is stopped, a stop device can be provided therefore. The angle then formed between backrest 50 and seat 51 is about 90°.

The seating device then undergoes a rotation R3 around joint 52, of about 90°. During this rotation R3, the angle existing at the end of rotation R2 between seat 51 and backrest 50 remains constant, close to 90°. In other words, rotation R3 drives the deployed seating device and therefore simultaneously concerns seat 51 and backrest 50, without performing a relative rotation between these two elements. When rotation R3 is about 90° around joint 52, seat 51 is substantially horizontal and backrest 50 is substantially vertical. In other words, at the end of rotation R3, the seating device is ready for use.

The seating device also comprises two armrests, on either side of the seat, for holding the user in position. Each of these armrests comprises a first part 55 and a second part 54 connected by a joint 59 (a pin for example) so as to enable a relative rotation of first part 55 with second part 54. In addition, first part 55 is connected to seat 51 by a joint close to and offset from joint 52, and second part 54 is connected to backrest 50 by a pivot connection 57. The offset of the joint between first part 55 and joint 52 enables deployment/folding of the armrests. Thus, upon deployment of the seating device, deployment of the armrests is driven by the deployment of seat 51 relative to backrest 50. Upon folding of the seating device, folding of the armrests is driven by the folding of seat 51 relative to backrest 50.

According to a variant, first part 55 could be connected to seat 51 directly by joint 52 (instead of a joint close to and offset from joint 52). In this case, first part 55 and/or second part 54 can comprise extendable arms. Therefore, the length of first part 55 and/or of second part 54 can vary and thus enable deployment/folding of the armrests.

Symmetrically, the diagrams from right to left show the various steps of the method of folding the seating device of the invention, by carrying out the steps in reverse order.

FIG. 9 schematically illustrates, by way of non-limitative example, a fourth embodiment for the deployment of the system according to the invention. The diagrams from left to right show various steps of the method of deploying the seating device of the invention.

In this embodiment, initially, the seating device is in folded position (left-hand diagram), seat 51 and backrest 50 being substantially horizontal, against one another, a joint 52 serving for relative rotation between backrest 50 and seat 51.

In a first step of deploying the seating device, a relative rotation R4 of backrest 50 is performed relative to seat 51, which remains substantially horizontal during this step, around joint 52. Thus, during this rotation R4, the angle formed between seat 51 and backrest 50 increases gradually. Rotation R4 is stopped when backrest 50 is substantially vertical, which corresponds to an angle between backrest 50 and seat 51 of about 90°. At the end of rotation R4, the seating device is in the position shown in the centre diagram.

The seating device is then moved vertically upwards into a position allowing a user (a patient for example) to sit on the seating device. The vertical translation F1 can notably be achieved by means of a slideway (not shown). During this vertical translation F1, the seating device is moved in the configuration corresponding to the end of rotation R4. In other words, the angle formed between seat 51 and backrest 50 at the end of relative rotation R4 between backrest 50 and seat 51 remains constant during vertical translation F1. Thus, backrest 50 and seat 51 undergo a vertical translation F1.

At the end of vertical translation step F1, the seating device is in the position shown in the right-hand diagram, a position allowing the user to sit on seat 50 of the seating device and to rest their back against backrest 50.

The seating device also comprises two armrests, on either side of the seat, for holding the user in position. Each of these armrests comprises a first part 55 and a second part 54 connected by a joint 59 (a pin for example) so as to enable a relative rotation of first part 55 with second part 54. In addition, first part 55 is connected to seat 51 by a joint close to and offset from joint 52, and second part 54 is connected to backrest 50 by a pivot connection 57. The offset of the joint between first part 55 and joint 52 enables deployment/folding of the armrests. Thus, upon deployment of the seating device, deployment of the armrests is driven by the deployment of backrest 50 relative to seat 51 during rotation step R4. Upon folding of the seating device, folding of the armrests is driven by the folding of backrest 50 relative to seat 51.

According to a variant, first part 55 could be connected to seat 51 directly by joint 52 (instead of a joint close to and offset from joint 52). In this case, first part 55 and/or second part 54 can comprise extendable arms. Therefore, the length of first part 55 and/or of second part 54 can vary and thus enable deployment/folding of the armrests.

Symmetrically, the diagrams from right to left show the various steps of the method of folding the seating device of the invention, by carrying out the steps in reverse order.

The deployment and folding embodiments presented in the above description are by no means limitative. On the contrary, the invention encompasses all possible deployment and folding embodiments for opening or closing the seating device.

The changes in position of the seating device for switching from the unfolded position to the folded position (and vice versa) can be achieved through a manual action by the user or through an automated action.

In the case of a manual action, the system can for example comprise at least one mechanical actuator such as a lever allowing to switch from the unfolded position to the folded position, and vice versa.

In the case of an automated action, the system can notably comprise at least one automatic actuator such as a cylinder, a rack and/or a powered swivel. In addition, the system can comprise a control device. The automatic actuator can notably be operated by the user via the device controlling the electric propulsion system. Indeed, the user can for example control the deployment (or the folding) of the system through an action on the control device (the user can press a button or enter a datum to generate the action), this action generating automatic control of the actuator. The actuator can therefore be electric. Thus, the control can be electrically transmitted between the control device and the automatic actuator.

1. A removable electric propulsion system (1) for a rolling object, said propulsion system (1) comprising a frame (2) provided with at least one wheel (3) driven by an electric machine (10), and at least one non-driven wheel (4), and means (5) for coupling said propulsion system (1) to said rolling object, said coupling means (5) comprising means for gripping and lifting at least one wheel of said rolling object, characterized in that the system comprises a seating device, said seating device comprising a seat (51) and a backrest (50), said seating device being foldable between a deployed position allowing a user to sit and a folded position

2. A propulsion system as claimed in claim 1, wherein said coupling means (5) comprise means for orienting at least one wheel of said rolling object in a direction forming a non-zero angle with the longitudinal direction (x) of said frame (2) of said propulsion system (1), preferably said coupling means (5) comprise means for orienting at least one wheel of said rolling object in a direction substantially perpendicular to longitudinal direction (x) of said frame (2) of said propulsion system (1).

3. A propulsion system as claimed in any one of the previous claims, wherein said seating device comprises at least one translation means and/or at least one rotation means relative to said frame (2).

4. A propulsion system as claimed in claim 3, wherein said rotation means comprises a connecting pin (52) of direction substantially perpendicular to the longitudinal direction of said frame, said connecting pin (52) being positioned at the junction between said backrest (50) and said seat (51).

5. A propulsion system as claimed in claim 3, wherein said translation means comprises at least one substantially vertical slideway

6. A propulsion system as claimed in claim 1 wherein, when said seating device is deployed, said seat (51) is substantially horizontal and said backrest is substantially vertical.

7. A propulsion system as claimed in claim 3 wherein, when said seating device is folded, 5 said backrest (50) and said seat (51) are substantially horizontal.

8. A propulsion system as claimed in claim 7, wherein said folded seating device is configured to support a user in a standing position.

9. A propulsion system as claimed in claim 1 wherein, when said seating device is folded, said backrest (50) and said seat (51) are substantially vertical.

10. A propulsion system as claimed in claim 1, wherein said seating device comprises at least two armrests (53), said armrests (53) comprising each at least a first part (55) and a second part (54), preferably said first part (55) being connected by a first pivot connection (56) to said seat (51), said second part (54) being connected by a second pivot connection (57) to said backrest (50), and said first and second parts (55, 54) being connected by a third pivot connection (59).

11. A propulsion system as claimed in claim 1, wherein said system comprises at least one toe clip, said toe clip being preferably foldable

12. A method for deploying/folding a seating device of a system as claimed in any claim 1 wherein, to deploy the seating device, at least one rotation (R1, R2, R3, R4) and/or a translation (F1) of said seating device is performed, folding of said seating device being achieved by carrying out the steps of deploying said seating device in reverse order.

13. A method as claimed in claim 12 wherein, to deploy said seating device, at least the following step is carried out:
performing a rotation (R1, R2, R4) of said seat (51) or of said backrest (50), relative to said backrest (50) or to said seat (51) respectively, the rotation preferably ranging between 80° and 120°, and being preferably stopped when said seat (51) is substantially horizontal or when said backrest (50) is substantially vertical.

14. A method as claimed in claim 12 wherein, to deploy said seating device, at least the following step is carried out:
performing an upward vertical translation (F1) of said seating device, said backrest (50) and said seat (51) being folded and in substantially vertical initial positions,
and the rotation (R1, R2, R4) and vertical translation (F1) steps can be carried out successively or simultaneously.

15. A method as claimed in claim 12 wherein, before or after the step of respective rotation (R1, R2, R4) between said seat (51) and said backrest (50), a rotation (R3) of said deployed or folded seating device of about 90° is performed around a substantially horizontal axis in order to position said seating device.

16. A method as claimed in claim 12, comprising a propulsion system as claimed in any one of claims 4 to 11 wherein, to deploy said seating device, at least the following steps are carried out:
performing an upward vertical translation (F1) of said connecting pin (52), said backrest (50) and said seat (51) being folded, in substantially horizontal initial positions and in substantially vertical final positions,
performing a rotation (R2), about said connecting pin (52), of said seat (51) or said backrest (50), relative to said backrest (50) or said seat (51) respectively,
performing a rotation (R3) of said seating device of about 90° around said connecting pin (52) in order to position said seating device.

17. A method as claimed in claim 12 wherein, to deploy said seating device, at least the following steps are carried out:
performing a rotation (R4) of said backrest (50), relative to said seat (51) respectively, rotation (R4) preferably ranging between 80° and 120°, and being preferably stopped when said backrest (50) is substantially vertical, said backrest (50) and said seat (51) being initially folded and in substantially horizontal initial positions,
performing an upward vertical translation (F1) of said seating device in order to position said seating device.

18. A coupled assembly comprising a rolling object (13) and an electric propulsion system (1) as claimed in any one of claim 1, said rolling object (13) being coupled to said electric propulsion system (1) by said coupling means (5).
